(19) United States
(12) Patent Application Publication
(10) Pub. No.: US 2005/0104976 A1
(43) Pub. Date: May 19, 2005

(54) System and method for applying inference information to digital camera metadata to identify digital picture content

(76) Inventor: Kevin Currans, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/715,265

(22) Filed: Nov. 17, 2003

(51) Int. Cl. H04N 5/76

(52) U.S. Cl. 348/231.5

(57) ABSTRACT

The present invention is directed to a system and method for correlating an image with information associated with the image comprising identifying image metadata for the image, wherein the image metadata includes information associated with conditions at the time of image capture, searching one or more information sources using parameters in the image metadata to collect inference information from the information sources, and displaying the inference information to a user.

### FIELD OF THE INVENTION

The present invention is generally related to annotating images with information obtained from external sources and more particularly related to using image metadata to infer information about the images.

### DESCRIPTION OF THE RELATED ART

Images may be stored in a digital format, such as images generated by digital cameras or digital video recorders. Digital images comprise information or data regarding the pixels of an image or series of images. Digital image files often include metadata or tagging data in addition to the pixel information. Metadata typically consists of information such as the time and date that a picture was taken, or Global Positioning System (GPS) data for the location where the picture was taken. The metadata may be stored in the header information of an image file. Digital cameras that incorporate GPS data into their images may have a GPS device incorporated with the camera or they may have a device that can be attached to the camera.

Metadata is helpful in sorting, storing, retrieving and indexing image data. The more metadata and other annotation information that can be stored in an image, the easier it is to store the image in an orderly format.

Photographers often have to manually label their images with commentary or other explanatory notes in order to help remember details about the scene shown in an image. Such commentary is often written on the back of printed images, which are then kept in a photo album or frame. Over time the writing is likely to fade and becomes harder to read. Additionally, certain details may be left out of the written notes. Extensive user input is required to select and create the explanatory information used to label the image, which can be very time consuming. As such, there is a need for a system to help annotate images in a less burdensome manner.

A goal of the present invention is to create a system and method whereby individuals are able to use metadata, associated with the image and created by an image capturing device, to obtain supplementary information related to the image from external sources of information such as a database or the internet. This system will drastically improve the current system of labeling images with supplemental information.

### BRIEF SUMMARY OF THE INVENTION

In an embodiment of the invention, a method of correlating an image with information associated with the image comprises identifying image metadata for the image, wherein the image metadata includes information associated with conditions at the time of image capture, searching one or more information sources using parameters in the image metadata to collect inference information from the information sources, and displaying the inference information to a user.

In another embodiment of the invention, a system for correlating an image with inference information comprises means for receiving an image file including image data and image metadata, and means for searching an information source using the image metadata to identify image inference information.

In a further embodiment of the invention, a storage device for storing image file information comprises memory fields for storing image data representing pixels in a captured image, memory fields for storing image metadata representing data associated with conditions at the time that the image was captured, and memory fields for storing inference metadata representing data that is generated by searching information databases using at least a portion of the image metadata.

### BRIEF DESCRIPTION OF THE DRAWINGS

FIG. 1 is a block diagram of a system for applying inference information to image metadata in accordance with embodiments of the present invention;

FIG. 2 is a block diagram of an image capture device used in implementing embodiments of the present invention;

FIG. 3 is an exemplary embodiment of metadata captured with graphical image data in a format that can used with embodiments of the present invention;

FIG. 4 is a system that uses image metadata to obtain inference information according to embodiments of the invention;

FIG. 5 is a flowchart representing an overview of the operation of embodiments of the present invention;

FIG. 6 is a flowchart illustrating methods used in one embodiment of the present invention;

FIG. 7 is an exemplary embodiment of metadata captured for a series of images in a format that can used with embodiments of the present invention; and

FIG. 8 is an example of an image including image and inference metadata generated for use with embodiments of the present invention.

### DETAILED DESCRIPTION

The present invention is directed to a system and a method for correlating image metadata with information obtained from various external sources. The system and method described herein may be used with still images, or single image files, as well as with video images, or sequences of image files. Information obtained such as GPS location information, time, date, temperature, image sensor orientation, or other data is added to the image file as metadata at the time of image capture. Metadata is a descriptive header that is associated with the image file. The metadata may be incorporated as part of the image file, where such metadata is located at the beginning of the image, or metadata may be stored separately from the image and associated with the image via some type of identifier or pointer.

Image metadata may consist of information such as the time the image was recorded, the location of the image, the pointing direction and angle of inclination of the camera when the image was recorded. The image metadata is used to obtain additional information that is added to the image file during post processing. This additional information is classified as inference information. The image metadata is used to locate inference information from external sources. The inference information can be used to further identify or define the content of the image.

In order to obtain the inference information, the user uploads an image file to a device, such as a computer or server. An application retrieves the image metadata, such as the GPS location of the image, direction, angle of inclination, and date/time information and uses those parameters to obtain information from other sources, such as: the national weather service, news sources, the U.S. Geological Survey, and various other information sources. The image metadata is used to search of these external sources for matching or related information. For example, location parameters in the metadata, such as a GPS latitude and longitude, may be used to search a U.S. Geological Survey website or database to determine terrestrial features at or near where the image was captured. Other database searches may then be searched for more information about the terrestrial features.

This inference information is displayed to the user, who has the option of adding the information to the image file as inference metadata. Selected inference metadata is retained with the image file in order to help identify the content of the image and to help the user remember events related to the image. The inference metadata also provides the user with advantages such as allowing the user to identify objects in the image field of view and allowing the photographer to remember and tell the “whole story” associated with the image.

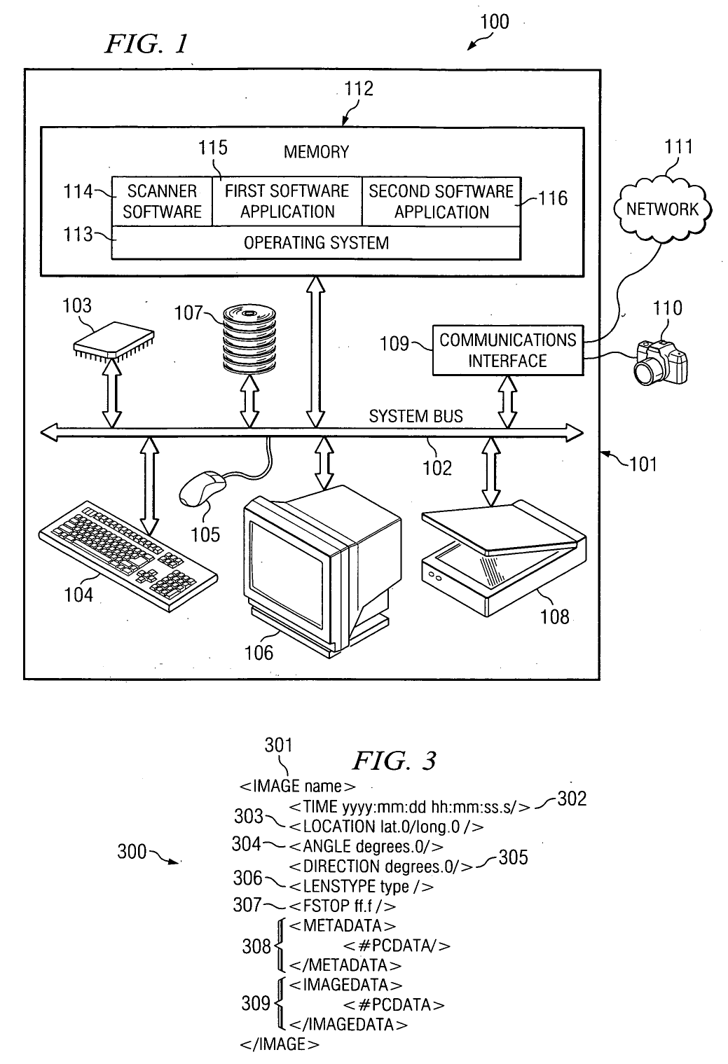

FIG. 1 is a block diagram of system 100 for applying inference information to image metadata in accordance with embodiments of the present invention. Computer 101 includes system bus 102 that allows communication between various elements. Computer 101 also includes processor 103, which may be any type of processor now know or later developed. Keyboard 104, mouse 105 and scanner 108 allow users to input information to computer 101. Information is displayed to the user through monitor 106. Storage device 107 is used to store programs and data for use by computer 101. Storage device 107 may be any form of electronic memory device, such as Random Access Memory (RAM), Read Only Memory (ROM), a hard drive or mass storage device, or the like.

Communications interface 109 allows computer 101 to communicate with external devices such as digital camera 110 or computer network 111. The computer system also may comprise memory 112 containing operating system 113 and application software, such as scanner software 114, first software application 115 and second software application 116. In some embodiments of the present invention, first software application 115 and second software application 116 may be stored on hard drives, CD-ROM, floppy disks, or other computer readable media typically used as storage 107. First and second application 115, 116 may be any programs run on computer 101, such as a browser program to view files on network 111 or a photo editing program to view image files from camera 110.

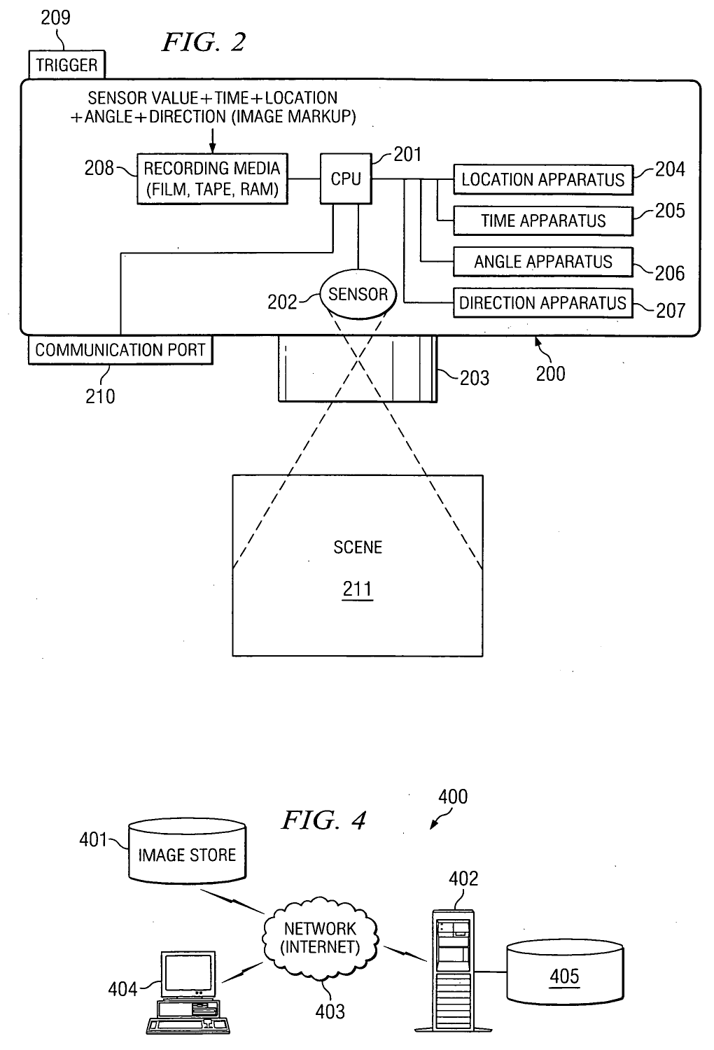

FIG. 2 is a block diagram of image capture device 200 used in implementing embodiments of the present invention. Image capture device 200 is used to capture, store, and display photographic image data. CPU or processor 201 controls the operation of image capture device 200. Image capture device 200 consists of sensor 202, such as a Charged-Coupled Device (CCD) that is used to capture scene 211. The photographic image data is obtained through lens 203 which has the capability to focus onto scene 211. Sensor 202 captures digital information representing scene 211 and image capture device 200 stores that data on recording media 208. Recording medium 208 may include a removable storage medium such as a SMARTMEDIA™ flash memory card, a COMPACTFLASH® card, a MEMORY STICK® card or a SD SECURED DIGITAL® memory card providing, for example, 64 megabytes or more of digital data storage.

Device 200 also comprises location apparatus 204, time apparatus 205, angle apparatus 206, and direction apparatus 207 which are used to generate image metadata. Location apparatus 204, which may be a GPS receiver, for example, is used to determine the location of image capture device 200 at the time of image capture. This positional data consists of at least the latitude and longitude of image capture device 200. Typically, once capture device 200 captures an image, image data is stored in storage medium 208 along with parameters, such as location or time and date information. These parameters may be stored in various formats, such as the Exchangeable Image File Format (EXIF) format.

Time apparatus 205, which may consist of an atomic or digital clock, is used to determine the time of image capture. Time apparatus 205 can also be used to identify the start and stop time for a series of digital images or for a video. Angle apparatus 206, which be an inclinometer, is used to determine the angle at which the image capture device 200 is pointed during image capture. For example, angle apparatus 206 will determine the angle at which the image capture device is pointed relative to the horizon during image recordation. Direction apparatus 207, which consist be a 3-D compass, is used to determine the direction in which the image capture device 200 is pointed at the time of image capture. The information obtained by devices 204-207 may be stored as image metadata with the image file.

Image capture device 200 also comprises trigger 209 which will be used to signal to image capture device CPU 201 to capture the image data 211. CPU 201 records image data 211 and all associated image metadata, such as data from location apparatus 204, time apparatus 205, angle apparatus 206, and direction apparatus 207, to recording media 208.

Image capture device 200 also includes communications port 210 that is used to communicate directly with other devices, such as computer 101. Communications port 210 may interface with computer 101 to transfer image data and image characterization information in the form of EXIF data using a variety of connections. For example, the data transfer may be supported by a direct electrical connection, such as by provision of a Universal Serial Bus (USB) or FIREWIRE® cable and interface, or by a wireless transmission path. Data may also be transferred using a removable recording media 208 that is physically inserted into an appropriate reader connected to computer 101.

FIG. 3 is an exemplary embodiment of metadata captured with graphical image data in a format that can used with embodiments of the present invention. Image metadata is stored with the image data at the time of capture. The metadata fields illustrated in FIG. 3 are not exclusive. It will be understood that other fields may be used and that some fields may be empty for any particular captured image.

Image file 300 includes image name 301, which may be a name entered by the user or a name that is automatically generated by the image capture device. Time field 302 includes date and time information that identifies when the image was captured. Location field 303 includes latitude and longitude information that identifies where the camera was when the image was captured. Angle field 304 and direction field 305 include, respectively, information regarding the angle of inclination and direction that the camera was pointing when the image was captured. Lens Type field 306 and fstop field 307 include information regarding the type of lens used to capture the image and other lens and camera parameters, such as aperture used to capture the image.

Additional metadata may be stored in field 308. This additional information may be added at the time of image capture or during later processing of the image file. Image data, representing the actual image captured, is stored in field 309.

FIG. 4 is a system that uses image metadata to obtain inference information according to embodiments of the invention. Network system 400 comprises image store 401 for holding image files. These image files may be uploaded from a camera or other image capture device. Image store may be a stand-alone mass storage device or may be a storage device that is connected to a users computer, such as computer 404. As discussed above with respect to FIGS. 1 and 2, a camera may be connected to a computer via a wireline or wireless connection and image files may be transferred to the computer. These image files may then be processed by the computer.

In one embodiment, network 403 connects image store 401 to computer 404. Network 403 may be a Local Area Network (LAN), Wide Area Network (WAN), intranet, the Internet, or any other wireline or wireless network. Computer 404 may be used to run an inference matching application according to the present invention. For example, the user may use computer 404 to search for supplemental data associated with image metadata. An application running on computer 404 is used to select an image file. The application identifies the metadata in the image file, such as the information represented in fields 302-308 of FIG. 3. This metadata is then matched to other information in external databases.

For example, a user uploads an image file to image store 401. Computer 404 identifies the metadata from the image file and selects the location field information. Computer 404 then connects to server 402 via network 403. Server 402, in one embodiment, runs a website for a geographical mapping service, such as the U.S. Geological Survey. Computer 404 provides the location information to server 402, which after querying location database 405, returns information about the area identified by the location information. For example, if the image file location metadata included latitude 45° 36′ N and longitude 122° 36′ W, then server 402 would identify the location Portland, Oreg. This information would be returned back to the user at computer 404. The user can then decide whether to further annotate the image file with this inference information. Since the latitude and longitude alone are not easily understandable by most users, the location name may be added to the image file, for example, as part of field 308 in FIG. 3. Similarly, other inference metadata may be added to the image file.

In another embodiment, the inference matching application runs on server 402, which is dedicated to performing searches for supplemental inference data associated with selected image files. In this embodiment, a user can upload image files to image store 401, which may be located at the same location as or remote from server 402, the images are then processed by server 402.

Upon execution of a search, processor 402 identifies the image metadata and searches various external sources for related information. External sources may consist of the national weather service, news services, other image databases with associated metadata, such as associated metadata collaboratively coalesced from previous matches, and the USGS or any other site that can be queried using the image file metadata. For example, a search of the national weather service for a particular time and location may return the weather conditions at the time and location when and where the image was captured. This information can be added to the image file metadata.

Various facts can also be added to the image file metadata. For example, a location database may provide more detailed information about a particular location in addition to basic city and state information. For example, if the image is of the White House in Washington, D.C., then searches using the image latitude and longitude information may identify the distance from the White House or other geographical features of the Washington D.C. area. Furthermore, the search may return the weather at the White House at the time the image was recorded because the image metadata provides the time that the image was recorded. Server 402 or computer 40 could then apply or merge the inference information to the image as inference metadata. The inference metadata is ultimately used to help identify the content of the image. After an image is marked up with the additional information, the image is classified as image data with an inference markup. After the search for supplemental inference information is completed, a user may choose to update the image, print the image with or without the markup, to store the image data with or without the inference markup on computer 404, in database 401 or on server 402.

The present invention allows users to take advantage of the collaborative nature of the Internet or of shared databases. Once an image has been processed, it can be stored on a central database, such as image store 401 for use or reference by other users. For example, a first user may save a processed image, including any metadata, to image store 401. Later when a second user processes related images, the first user's image may be used in processing the other images. The second user's images may be associated with the same event as the first user's images. As a result, much of the general metadata, such as a location name, weather conditions, and nearby sites, will apply to both users' images. The second user can select a portion of the metadata to be added to his images. Additionally, if the images are stored on image store 401, the first or second user may update the processing for those images at a later time. As a result, information that was not available when the images were first processed may be found during a second or subsequent processing.

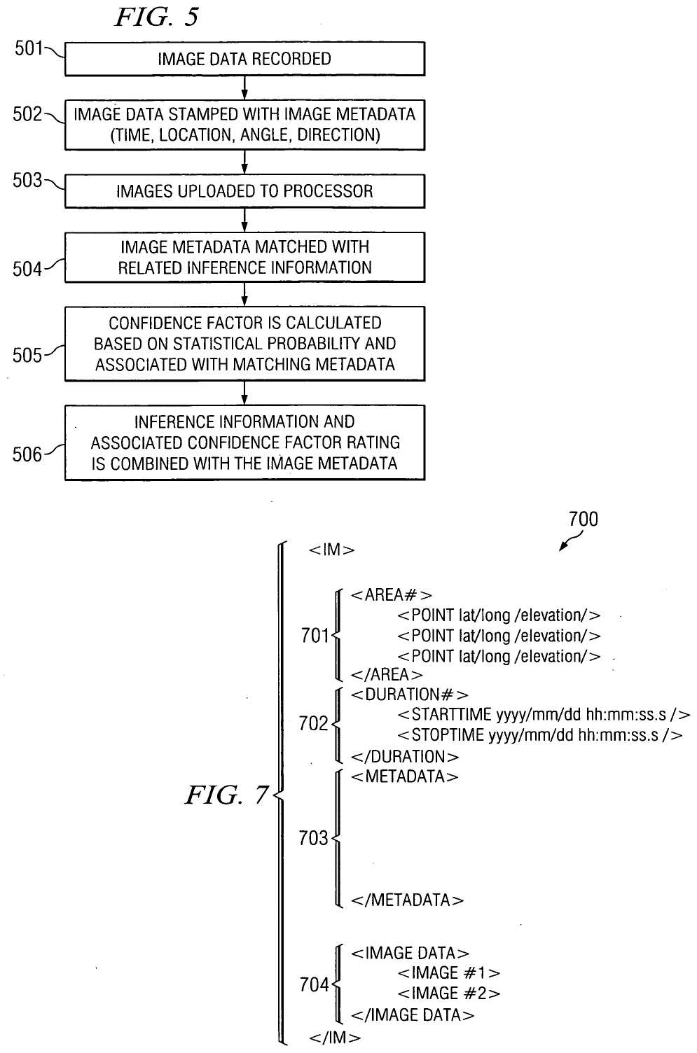

FIG. 5 is a flowchart representing an overview of the operation of embodiments of the present invention. At 501, the image is recorded. At 502, contemporaneous with recording the image, metadata is appended to the image file. This metadata may include location, date, time, pointing angle or other relevant information related to the captured image. Once the images have been recorded, the images are uploaded to a processor or computer for inference matching at 503. At 504, the metadata from the images is matched to other information, for example, in the manner described above with respect to FIG. 4.

At process 505 a confidence factor is calculated based on statistical probability and is associated with matching metadata. The confidence factor may be used, for example, to rate how closely certain metadata matches an image being processed. After matching is completed, the inference information and associated confidence factor rating is combined with the image metadata at 506.

FIG. 6 is a flowchart illustrating methods used in one embodiment of the present invention. An image is uploaded for processing at 601. Metadata is read from the image file at 602. Once the image metadata has been read, a search for inference data is performed based on various search criteria as illustrated at 603-606. For example, a query based on image location and image time is shown at 603 and a query based on image location alone is shown at 604. A search may also be based on the area that is within the viewing area of the camera or the view-shed. The area covered by the camera or view-shed is calculated at 605. At 606, the view-shed is used to search for inference information.

After the appropriate search criteria have been selected, the search will be processed at 607. The time required to process a search will vary depending on the amount of inference data discovered. After processing the search, all inference data matches are sorted and prioritized at 608. Inference data matches will be prioritized and sorted based on the closest matches to the selected search criteria selected in steps 603-606. After the inference data matches are prioritized, the user selects whether the images are to be updated with inference data at 609. The images may be automatically updated or updated with user supervision.

If the user decides to supervise the image update, a user interface is created and displayed to the user at 610 so that the user may view the inference information and select information to be added to the image file. In one embodiment, the interface consists of one or more windows displaying images and related inference information and the user uses an input device, such as a mouse or keyboard, to select information to be added to the image file. The inference is presented to the user at 611 and the user selects the desired data 612. The supervised process illustrated in 610-612 allows the user to eliminate duplicate information and to prevent irrelevant or unwanted information from being added to the image file. For example, a user may decide to keep location-based inference information such as national monuments or places of interest that are near the location of the captured image recordation. However, the user may also choose to reject information related to the weather at the time of image recordation. After a user has selected the desired inference data, this data will be added to the image file at 613. A confidence factor and supervisor identifier may also be added to the image at 613.

If a user decides to choose automatic image updating at 608, then all inference data that is matched by the search criteria at 603-606 is automatically added to the image file at 613. The selection of supervised or automatic updating may be preset or may be a default setting so that the user does not have make a choice for each image file. At 614, the updated image file is presented to the user for review, this may be a display of the metadata, the image or both. At 615, the user decides if he is satisfied with the image file and, if satisfied has the option of printing the image and/or metadata at 616. If the user is not satisfied with the image file at 615, then the inference information is displayed again at 611 and the user has the option of changing his selection. After approving the image file at 615, the user can save the image to a database at 617.

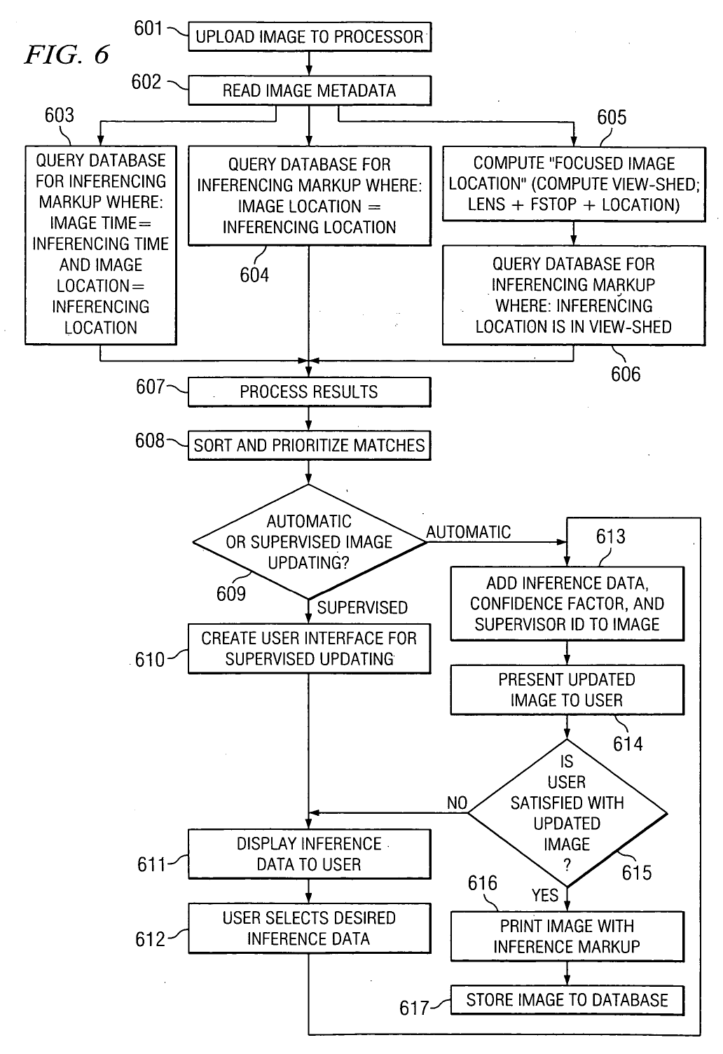

FIG. 7 is an exemplary embodiment of metadata 700 captured for a series of images in a format that can used with embodiments of the present invention. In some embodiments, a series of related images, such as a sequence of pictures or a video clip, may be stored as a single file. Metadata can also be applied to these files as shown in FIG. 7. Area field 701 includes a number of locations, which may represent the location of each image in a sequence of images. Alternatively, field 701 may be the start and end locations of a video clip and/or the locations of the camera at certain times during the video capture. Duration field 702 includes a start and stop date and time for the sequence of images or video clip. Alternatively, duration field 702 may have a date and time entry for each image in a sequence of images. Metadata field 703 includes other information related to the sequence of images or video clip, such as inference information added using the present invention or other data related to the images. It will be understood that other fields may be added to image file 700, including camera parameters, such as fstop or aperture used to capture the image. Image data field 704 is used to store the actual image data for each image in the sequence or for the video clip.

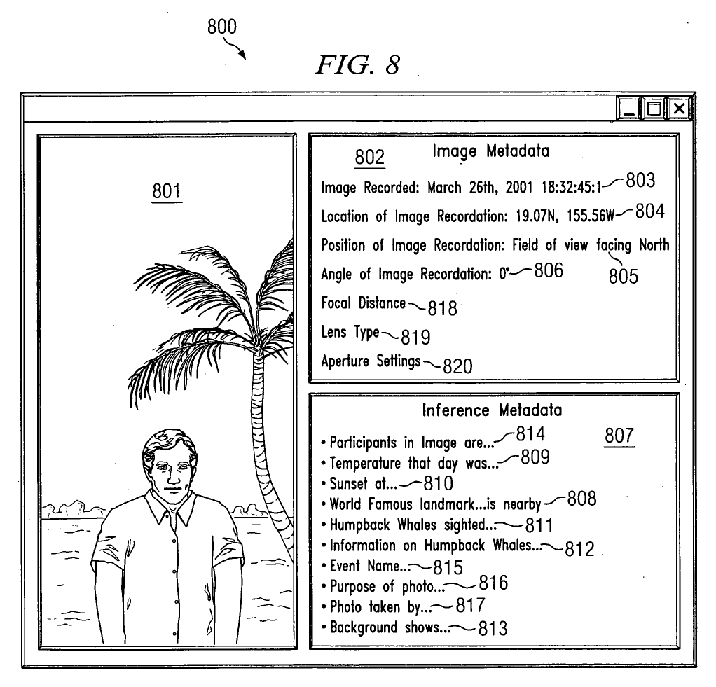

FIG. 8 is an example of an image including image and inference metadata generated for use with embodiments of the present invention. Display 800 includes image 801, which may be a still image, a photograph, a sequence of images, thumbnail views of a series of images, a video clip or any other image display. Image 801 is generated, for example, from image data field 309 or 704 in FIGS. 3 and 7. Image metadata 802 is data that is stored by the camera at the time of image capture. Image metadata 802 may be stored, for example, in fields 302-307 or 701-702 of FIGS. 3 and 7.

Image metadata 802 is used in the present invention to identify inference information related to image 801. Date and time metadata 803 identifies the when the image was captured. Location metadata 804 identifies where the image was captured and can be used to identify features in or near the image. Camera direction metadata 805 and camera angle/focal distance/aperture setting/lens type metadata 806 identify the direction that the camera was pointing when the image was captured and can be used to identify the area covered by the camera's field of view. Other metadata may include focal distance 818, lens type 819, and aperture setting 820.

Using image metadata 802, the present invention generates inference metadata 807. For example, nearby landmarks (808), such as National Parks, beaches, and tourist attractions, can be identified from location metadata 804. Once the image location is known, the weather (809), sunrise/sunset (810) and other atmospheric conditions can be determined for the location and time of image capture. Inferred data, such as the location name, can be further processed to identify additional inference information. For example, having identified the location as a famous beach, other information about that location, such as flora and fauna (811, 812) that can be found at the beach, are determined.

Using location metadata 804 along with field of view metadata 805, 806, the area that was shown in the captured image can be determined. Using this information, objects or events that may appear in the image or image background (813) can be determined. For example, if an image was taken near the time of sunset and the field of view indicates that the camera was pointing west, the inference information may suggest that a sunset was captured. Geographic landmarks, such as a mountain, are identified as possible background objects (813) if the field of view indicates that the landmark may have been visible in the image.

Inference metadata 807 is presented to the user, who then selects information to be added to or linked to the image file. Once the inference information is added to the image file, such as by adding the information in field 308 or 703 in FIGS. 3 and 7, then this information will be available whenever the user views the image or opens the image file. The user can also add other information to inference metadata 807, such as the names (814) of the people in the picture, the event shown (815), the purpose of the image (816) or who took the picture (817).

1. A method of correlating an image with information associated with the image comprising:
identifying image metadata for the image, wherein the image metadata includes information associated with conditions at the time of image capture; and
searching one or more information sources using parameters in the image metadata to collect inference information from the information sources.

2. The method of claim 1 further comprising:
receiving one or more inputs from the user identifying selected inference information; and
adding the selected inference information to an image file for the image.

3. The method of claim 1 further comprising:
receiving one or more inputs from the user identifying selected inference information; and
adding the selected inference information to an inference metadata file linked to the image.

4. The method of claim 1 wherein the image metadata includes parameters selected from the group consisting of:
time of image capture;
date of image capture;
location of image capture;
direction of image capture device during image capture; and
angle of image capture device during image capture.

5. The method of claim 1 wherein the image metadata includes a latitude and longitude of the image capture device.

6. The method of claim 1 wherein the image metadata includes location information generated by tracking multiple earth-orbiting satellites.

7. The method of claim 1 further comprising:
printing the image, the image metadata, and selected inference information.

8. The method of claim 1 wherein the inference information is selected from the group consisting of:
landmarks located near the image;
weather at the time of image capture;
information related to the location where the image was captured; and
objects that are within the field of view of the image capture device.

9. The method of claim 1 further comprising:
searching a first database using the image metadata to identify the inference information; and
searching a second database using the inference information to identify additional inference information.

10. The method of claim 1 wherein said image metadata is associated with a series of images taken over a period of time.

11. The method of claim 1 wherein said image metadata is associated with a series of images taken while the location of the image capture device was changing.

12. A system for correlating an image with inference information comprising:
means for receiving an image file including image data and image metadata; and
means for searching an information source using the image metadata to identify image inference information.

13. The system of claim 12
means for displaying the image inference information to a user;
means for receiving one or more inputs from the user identifying selected inference information; and
means for adding the selected inference information to an image file for the image.

14. The system of claim 12
means for displaying the image inference information to a user;
means for receiving one or more inputs from the user identifying selected inference information; and
means for adding the selected inference information to an inference metadata file linked to the image.

15. The system of claim 12 wherein the image metadata includes parameters selected from the group consisting of:
time of image capture;
date of image capture;
location of image capture;
direction of image capture device during image capture; and
angle of image capture device during image capture.

16. The system of claim 12 wherein the conditions at the time of image capture include a latitude and longitude of the image capture device.

17. The system of claim 12 wherein the conditions at the time of image capture include location information generated by tracking multiple earth-orbiting satellites.

18. The system of claim 12 further comprising:
means for printing the image, the image metadata, and selected inference information.

19. The system of claim 12 wherein the inference information is selected from the group consisting of:
landmarks located near the image;
weather at the time of image capture;
information related to the location where the image was captured; and
objects that are within the field of view of the image capture device.

20. The system of claim 12 further comprising:
means for searching a first database using the image metadata to identify the inference information; and
means for searching a second database using the inference information to identify additional inference information.

21. The system of claim 12 wherein said image metadata is associated with a series of images taken over a period of time.

22. The system of claim 12 wherein said image metadata is associated with a series of images taken while the location of the image capture device was changing.

23. A storage device for storing image file information comprising:
memory fields for storing image data representing pixels in a captured image;
memory fields for storing image metadata representing data associated with conditions at the time that the image was captured; and
memory fields for storing inference metadata representing data that is generated by searching information databases using at least a portion of the image metadata.

24. The storage device of claim 23 further comprising:
memory fields for storing a confidence factor relating to matched inference data and an identify of a person supervising the match.
